(19) United States
(12) Patent Application Publication
(10) Pub. No.: US 2007/0056422 A1
(43) Pub. Date: Mar. 15, 2007

(54) Pin-hole puncher

(76) Inventor: Chung-Heng Lee, Hsintien City (TW)

Correspondence Address: COOPER & DUNHAM, LLP, 1185 AVENUE OF THE AMERICAS, NEW YORK, NY, 10036, US

(21) Appl. No.: 11/225,715

(22) Filed: Sep. 13, 2005

(51) Int. Cl. B26D 5/08

(52) U.S. Cl. 83/582; 83/633; 83/686

(57) ABSTRACT

A pin-hole puncher has a base, a cutting die and a handle. The base has a chassis and an upper plate. A slot is defined between the chassis and the upper plate to receive with the paper. The cutting die is mounted on the chassis and has at least one blade and at least one rod which can control the down height, and each blade has a curved bottom edge. The handle bridges on an upper end of the cutting die. The cutting die is driven by the handle to cut the paper in the slot so that specific figures are shown on the paper with a three-dimensional effect and an aesthetic feeling.

### BACKGROUND OF THE INVENTION

1. Field of the Invention

The present invention relates to a pin-hole puncher, and more particularly to a pin-hole puncher which can incise to form three-dimensional figures on paper.

2. Description of Related Art

A first conventional pin-hole puncher is used to cut holes in edges of papers for filing. A second conventional pin-hole puncher with different cutting dies provided in an interior thereof can incise paper to form special figures for decoration so that the incised portion is separated from the original paper which is defined with holes configured to mate with the figures.

However, it is difficult for a user to use the second conventional pin-hole puncher to sculpture figures on a paper, another tools, such as knife are necessary for cutting specific figures on a paper so that the convention pin-hole puncher is not versatile in use.

Therefore, the invention provides a pin-hole puncher to mitigate or obviate the aforementioned problems.

### SUMMARY OF THE INVENTION

The main objective of the present invention is to provide a pin-hole puncher with which it is easy for a user to sculpt specific figures on papers.

The pin-hole puncher in accordance with the present invention has a base, a cutting die and a handle. The base has a chassis and an upper plate. A slot is defined between the chassis and the upper plate to receive with the paper. The cutting die is mounted on the chassis and has at least one blade and at least one rod which can control the down height, each blade has a curved bottom edge. The handle bridges on an upper end of the cutting die.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a pin-hole puncher in accordance with the present invention;

FIG. 2 is an exploded perspective view of a base and a cutting die of the pin-hole puncher in FIG. 1;

FIG. 3 is a cross sectional view of the cutting die of the pin-hole puncher in FIG. 2;

FIG. 4 is a cross sectional view of the cutting die of the pin-hole puncher in FIG. 1;

FIG. 5 is an operational cross sectional view of the cutting die of the pin-hole puncher in FIG. 1;

FIG. 6 is a sectional view of the cutting die, a hole and an elastic pad of the pin-hole puncher in FIG. 2; and

FIG. 7 is a perspective view of a sculpture on paper done by the pin-hole puncher in accordance with the present invention.

### DETAILED DESCRIPTION OF THE PREFERRED EMBODIMENT

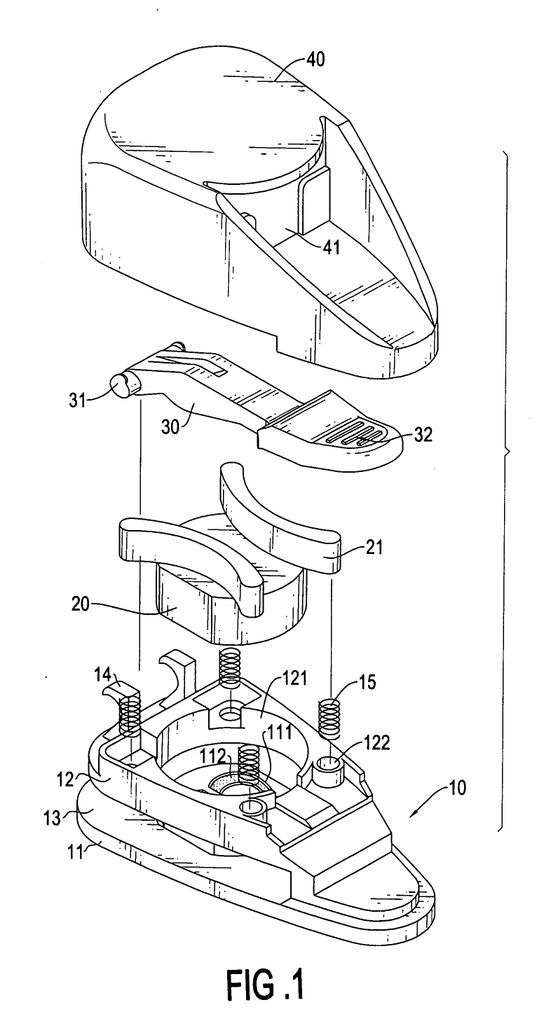

With reference to FIGS. 1, a pin-hole puncher comprises a base (10), a cutting die (20) provided on the base (10), a handle (30) and a cap (40).

The base (10) comprises a chassis (11) provided in a lower end thereof and an upper plate (12) provided on the chassis (11). A hole (111) is defined in a lower end of the chassis (11) and configured to mate with the cutting die (20). An elastic pad (112) is provided in an interior of the hole (111) and a channel (121) is defined in a center of the upper plate (12) thereby the cutting die (20) being received into the channel (121). Multiple orifices (122) are respectively and symmetrically defined in a periphery of the channel (121) and multiple resilient members (15) are respectively mounted in the orifices (122). In the preferred embodiment of the pin-hole puncher, the resilient members (15) are springs.

The chassis (11) is connected to a first end of the upper plate (12) and a gap is defined between the upper plate (12) and the chassis (11) thereby defining with a slot (13) between them to receive with paper. Multiple hooks (14) are respectively formed in a second end of the upper plate (12) and opposed to the first end.

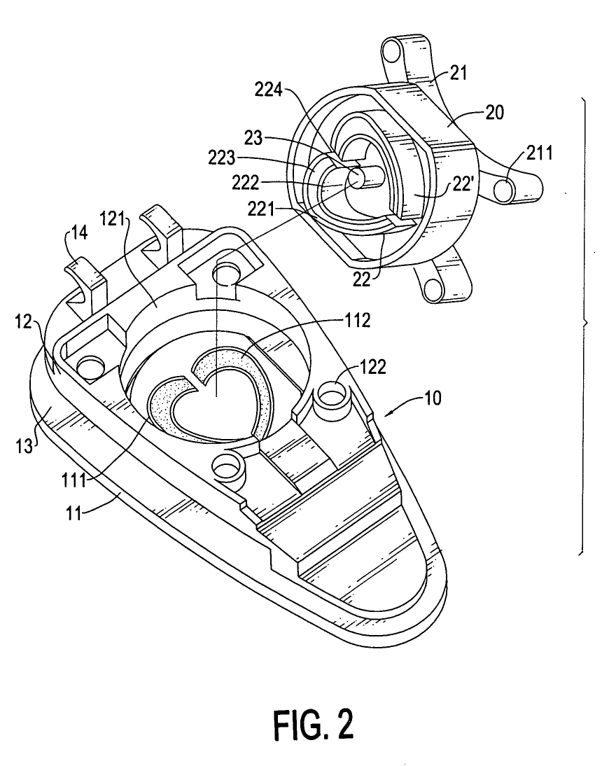

With further reference to FIG. 2, the cutting die (20) has a chamber defined in a lower end thereof and multiple ribs (21) are mounted on an upper end thereof. Each rib (21) has an opening (211) defined in a lower end thereof and corresponding to each orifice (122) so that the cutting die (20) is supported by the resilient members (15) and held inside the channel (121). With the resilient force, the cutting die (20) can resume an original status after being pressed on the paper.

Two blades (22, 22′) are symmetrically mounted in an interior of the chamber of the cutting die (20), and a rod (23) is mounted between the blades (22, 22′). In the preferred embodiment of the pin-hole puncher, the blades (22, 22′) have a concentric-heart-like cross section. Each blade (22, 22′) has a semi-heart-like outer cutting edge (221) to sculpt a semi-heart-like outer heart figure in the paper and a semi-heart-like inner cutting edge (222) parallel to the outer cutting edge (221) to sculpt a semi-heart-like inner heart figure. A concave surface (223) is defined between the outer cutting edge (221) and the inner cutting edge (222). Two gaps (224) are respectively formed in two ends of the blades (22, 22′), such that the blades (22,22′) are not connected to each other. In a preferred embodiment, each blade (22,22′) has a curved bottom edge to make the blade have different heights at different segments.

The handle (30) has a bar (31) transversely formed in a first end thereof and a head (32) formed in a second end thereof and opposed to the first end. The bar (31) is pivotally connected to the hooks (14), and a middle portion of the handle (30) is contacted to a top end of the cutting die (20) so that the cutting die (20) is moved downwardly and driven by the middle portion of handle (30) when the head (32) is pressed downwardly.

The cap (40) is sleeved around the cutting die (20) and the handle (30) and a lower end of the cap (40) is connected to the upper plate (12) to fasten the cutting die (20) to the handle (30). An open end (41) is defined in a front end of the cap (40) thereby the head (32) extends through and can be moved upwardly or downwardly in the open end (41).

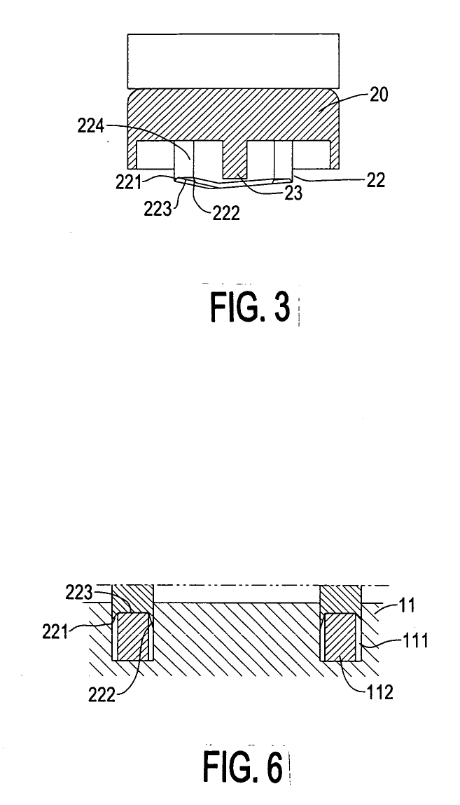

With reference to FIG. 3, the rod (23) is formed on the bottom of the cutting die (20) between the blades (22,22′) and has a length slightly shorter than the heights of the outer cutting edges (221) and the inner cutting edges (222) of the blades (22,22′) and slightly longer than the heights of the blades (22,22′) at the ends defining the gaps (224). When the rod (23) is moved to contact with the chassis (11), the cutting die (20) can not move downwardly again.

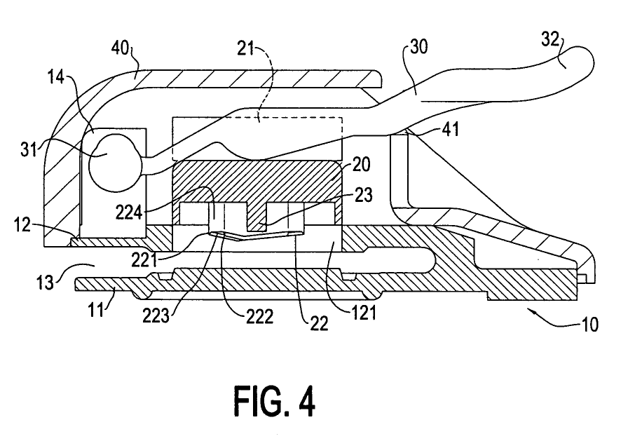

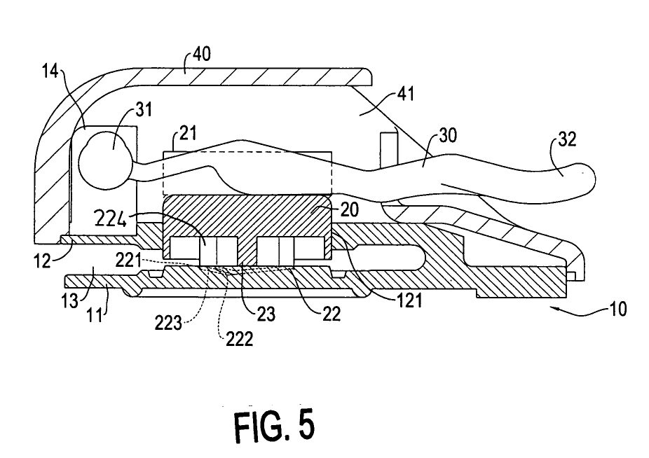

With reference to FIGS. 4-5, when the cutting die (20) is moved downwardly towards paper, the outer cutting edges (221) and the inner cutting edges (222) respectively incise the paper. With further reference to FIG. 6, furthermore, when the outer cutting edge (221) and the inner cutting edge (222) are inserted into the hole (111), the elastic pad (112) is pressed against the concave surfaces (223) thereby the paper being not dropping into the hole (111). When the rod (23) contacts the chassis (11), the movement of the cutting die (20) will be stopped. Because the length of the rod (23) is slightly longer than that of the blades (22,22′) at the ends defining the gaps (224), the blades (22,22′) at the ends defining the gaps (224) will not contact and cut the paper. Consequently, portion on the paper corresponding to the gaps (224) is not separate from the paper so that the concentric heart-like figure cut by the blades (22,22′) are not separated from the paper so as to form a three-dimensional effect.

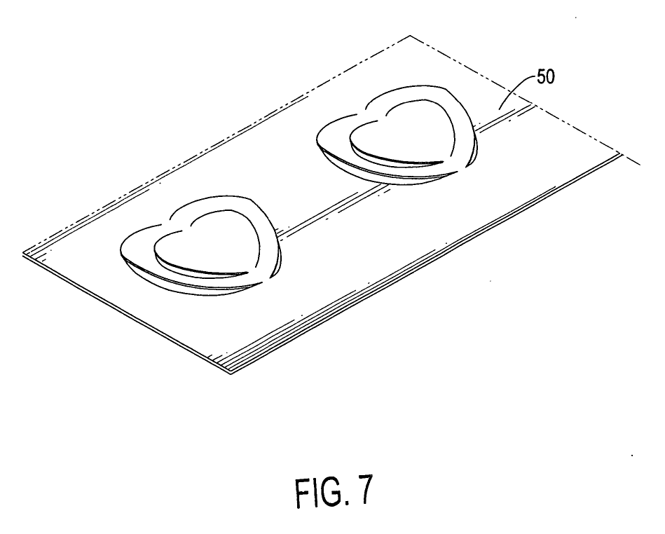

With reference to FIG. 7, the figure on a paper (50) corresponds to the blades (22, 22′) to represent a three-dimensional appearance.

With no connection between the two blades (22, 22′) and with the arrangement of the lower ends of the rod (23) and the blades (22, 22′) with different lengths, the cutting lines are independent on the paper when the cutting die (20) incises the paper. Hence, the specific figures are shown on the paper with three-dimensional effect. In different preferred embodiment, the cutting die can be changed and the quantity and the position of the rod also can be adjusted.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pin-hole puncher comprising:
a base (10) having a chassis (11) formed in a lower end thereof and an upper plate (12) formed in an upper end thereof, a slot (13) transversely defined between the chassis (11) and the upper plate (12), a hole (111) defined in a center of the chassis (11) and a channel (121) defined in a center of the upper plate (12) and corresponding to the hole (111);
a cutting die (20) mounted on the upper plate (12) and received into the channel (121) and having at least one blade (22) and at least one rod (23), each one of the at least one blade (22) having a curved bottom edge to make the blade have different heights at different segments; and
a handle (30) bridged on an upper end of the cutting die (20).

2. The pin-hole puncher as claimed in claim 1, wherein a cap (40) is mounted on the cutting die (20) and the handle (30), an open end (41) is defined in a center of the cap (40), and a head (32) is integrally formed in a first end of the handle (30) whereby the head (32) crosses through the open end (41).

3. The pin-hole puncher as claimed in claim 1, wherein the hole (111) is configured to mate with the cutting die (20) and an elastic pad (112) is provided in the hole (111).

4. The pin-hole puncher as claimed in claim 3, wherein multiple hooks (14) are respectively mounted on an end of the upper plate (12), a bar (31) is transversely and integrally formed in a second end of the handle (30) and opposed to the first end, whereby the bar (31) is pivotally connected to the hooks (14).

5. The pin-hole puncher as claimed in claim 4, wherein two blades (22,22′) are mounted in the cutting die (20); and
each blade (22, 22′) has an outer cutting edge (221), an inner cutting edge (222) parallel to the outer cutting edge (221), a concave surface (223) defined between the outer cutting edge (221) and the inner cutting edge (222) and two gaps (224) respectively formed in two ends of the blades (22, 22′).

6. The pin-hole puncher as claimed in claim 5, wherein one rod is formed on a bottom of the cutting die (20) between the blades (22,22′) and has a length slightly shorter than the heights of the outer cutting edges (221) and the inner cutting edges (222) of the blades and slightly longer than the heights of the blades (22,22′) at the ends defining the gaps (224).
